(19) United States
(12) Patent Application Publication
(10) Pub. No.: US 2025/0382404 A1
(43) Pub. Date: Dec. 18, 2025

(54) MULTI-COMPONENT RESPONSIVE COPOLYMERS AND APPLICATIONS THEREOF

(71) Applicant: AESCULATECH, INC., Los Angeles, CA (US)

(72) Inventor: Roby Menefee, Los Angeles, CA (US)

(21) Appl. No.: 18/746,505

(22) Filed: Jun. 18, 2024

(51) Int. Cl. C08F 220/56; C08F 220/18

(52) U.S. Cl. CPC C08F 220/56; C08F 220/1804; C08F 2800/10

(57) ABSTRACT

Described herein are compositions and uses for an adaptive polymer system. Components of the polymer are used to balance smart behavior around an environmental trigger point with desirable material properties and formulation additives. The APS allows engineering of smart materials and products with desired smart behaviors and material properties on both sides of the trigger point for that behavior. When applied to solvent-based polymer gels, the APS allows for precise control of cloud point behavior and material properties that enable a range of consumer, biomedical, and industrial applications.

### BACKGROUND

There exist many applications for which phase change materials can be practically applied to create a cohesive or form-fitting solution. While these materials often include thermoplastics and thermoset polymers, smart gel can provide a unique and advantageous solution.

Smart gels are mixtures of polymer, solvents, and sometimes other excipients that exhibit unique behavior as a result of changes in bonding interactions. This behavior, often a change in the physical state of the material, is facilitated by a sensitivity to pH, temperature, light, or another stimulus.

In the case of simple N-isopropylacrylamide (NIPAM) polymer hydrogels, this change in behavior is commonly observed as a transition from a clear liquid to an opaque gel above a certain trigger temperature, commonly referred to as a cloud point (Tcp). If the concentration of the poly(N-isopropylacrylamide) (PNIPAM) in the hydrogel is increased, the viscosity of the liquid state and cohesiveness of the solid phase increase. As a result, crossing the Tcp results in a transition from a clear viscous gel to a soft solid.

While this unique behavior is useful in some applications, PNIPAM hydrogels are characteristically fragile. This limits their use to a small subset of the potential uses for a liquid-to-solid material.

Recently, several efforts have been made to customize the behavior of PNIPAM polymers to better suit a specific application. The exact material changes achieved present differently depending on the monomeric components of the polymer, the concentration of the polymer, and whether any other excipients are included in the formulation.

In one example, binary copolymers of NIPAM with secondary monomers at lower percentages have been observed to impact the Tcp, and even strengthen hydrogels. These two effects are sometimes observed in tandem. A monomer may lead to a more cohesive solid form, but at the cost of lowering the transition point below a point of utility for a certain application.

Additionally, the inclusion of additional solvents like alcohols (isopropyl alcohol, ethanol, methanol, etc.) has demonstrated something known as the co-solvent effect—a lowering of the Tcp that defies expectations of higher polymer solubility and therefore a higher Tcp. As a result, certain mixtures that would usually rely on the use of multiple solvents for homogenization and promoting material stability cannot be combined with smart hydrogels.

Another effect that has also been well documented is the impact of salts on the hydrogel transition. Hoffmeister series ions all decrease the Tcp to varying degrees. This “salting-out” effect would cause difficulty to anyone attempting to combine other ingredients with the hydrogel. As a result, common ingredients like salt-form acids and other ionic excipients are often incompatible with smart hydrogels or alter the behavior in unpredictable ways.

Another effect that has also been documented is the pH sensitivity of smart hydrogel transitions from liquid to solid. Certain monomers, specifically those with hydroxyl or carboxylic acid groups have also demonstrated an LCST that can be manipulated based on the pH of the overall smart hydrogel. This limits the inclusion of acidic or basic excipients to smart hydrogels, which may no longer exhibit the desired material properties once those components are added.

In general, the sensitivity of cloud point behavior results in formulation difficulties for NIPAM polymers and copolymers. Ingredients like acids, salts, peptides, extracts, vitamins, and therapeutic small molecules can alter gelation conditions even at comparatively low concentrations in the formula.

In view of the foregoing, there exists a need for smart polymer hydrogels which can be formulated with stimulus responsive trigger points uncoupled from any additives or additional ingredients. In addition, the incompatibility of certain solvents at desirable concentrations, salts or other molecules, with these hydrogels illustrates the need for smart polymer hydrogels which are formulation adaptable. Such hydrogels would allow for the precise targeting of stimulus response, material properties, and formulation ingredients without compromise for the sake of another variable. The present disclosure provides compositions, methods, and kits that address this need and directly apply those advantages to use cases.

### SUMMARY

Generally, provided herein is polymer system that facilitates the development of materials and formulations exhibiting varied material properties. One goal for these polymers is that they may be tailored to a formulation by changing the ratios of polymeric constituents rather than the constituents themselves. This Adaptive Polymer System (APS) can be used to achieve a wide range of desired phase changes, material properties, and multi-ingredient formulations without compromise of one of these attributes for the other. The system comprises, for example, a quaternary polymer whose environmentally sensitive behavior is largely contributed by one monomer but is influenced by the other three monomers for greater control over an environmentally-induced behavior (smart behavior), mechanical properties, solubility or a combination of attributes.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

Described herein is an adaptive polymer system (APS) that enables a wide range of material properties and behaviors. The APS is used to engineer precise behaviors in stimulus responsive polymers such that they that undergo a controlled change in material properties, behavior, or structure upon a selected environmental stimulus. The specific condition at which this change occurs is referred to as the trigger point. These polymers may require formulation with solvents or other excipients to elicit these behaviors.

This APS can be adapted to a wide range of applications including but not limited to medical sealing, drug release, cosmetics, skincare, industrial materials, smart apparel, and additive manufacturing.

### Definitions

Unless otherwise stated, the following terms in this application have the definitions given below. The Section headings used herein are for organizational purposes only and are not to be construed as limiting the subject matter described.

The term “polymer” may refer to a homo-polymer, a copolymer, a multi-polymer, or a mixture thereof. The term “polymer” may also be used to refer to a formulation that includes a polymer.

The term “lower critical solution temperature” (LCST) is the temperature below which a temperature-sensitive polymer is miscible. LCST and cloud point temperature are used interchangeably despite have slightly different scientific meanings.

The term “gelation point” refers to the condition at which an environmentally responsive formulation undergoes a phase transition to a more gelled state, reflected in a loss of fluidity. Gelation point and cloud point (Tcp) are used interchangeably.

The term “trigger point” refers to the condition upon which an environmentally responsive formulation undergoes a change in material properties, behavior, or structure. In some embodiments, a trigger point may be a gelation point or a LCST.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if a thermoresponsive polymer is disclosed and discussed, and a number of different additives are discussed, each and every combination of thermoresponsive polymer and additive that is possible is specifically contemplated unless specifically indicated to the contrary. For example, if a class of thermoresponsive polymers A, B, and C are disclosed, as well as a class of additives D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an additive” includes mixtures of two or more additives and the like.

“Optional” or “optionally” means that the subsequently described event or circumstance can or cannot occur, and that the description includes instances where the event or circumstance occurs and instances where it does not.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

It should be noted that ratios, concentrations, amounts, and other numerical data can be expressed herein in a range format. It will be further understood that the endpoints of each of the ranges are significant both in relation to the other endpoint and independently of the other endpoint. It is also understood that there are a number of values disclosed herein and that each value is also herein disclosed as “about” that particular value in addition to the value itself. For example, if the value “10” is disclosed, then “about 10” is also disclosed. Ranges can be expressed herein as from “about” one particular value and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. For example, an acrylic acid residue in a copolymer used herein refers to one or more —CH₂CH(CO₂H)— units in the copolymer, regardless of whether acrylic was used to produce the copolymer.

As used herein, the term “polymer” may refer to a homo-polymer, a copolymer, a tri-polymer and other multi-polymer, or a mixture thereof.

As used herein, the term “vinyl polymer” includes all polymers derived from vinyl monomers which have a backbone chain comprised of covalently linked carbon atoms. Vinyl polymers may be homopolymers, copolymers with 2 or more constituent monomer groups, cross-linked, or mixed. Cross linked vinyl polymers may have backbones which are not exclusively covalently bonded carbon atoms, or backbone regions which are not exclusively covalently bonded carbon atoms.

As used herein, the term “lower critical solution temperature” (LCST) or “lower consolute temperature” is the critical temperature below which a thermoresponsive polymer is miscible for all compositions.

As used herein, the term “admixing” is defined as mixing two or more components together so that there is no chemical reaction or physical interaction. The term “admixing” also includes the chemical reaction or physical interaction between the two or more components.

As used herein, the term “subject” or “individual” as used herein includes mammals. Non-limiting examples of mammals include humans, dogs, cats, and mice, including transgenic and non-transgenic mice. The methods described herein can be useful in both human therapeutics, pre-clinical, and veterinary applications. In some embodiments, the subject is a mammal, and in some embodiments, the subject is human.

As used herein, “instruction(s)” means documents describing relevant materials or methodologies pertaining to a kit. These materials may include any combination of the following: background information, list of components and their availability information (purchase information, etc.), brief or detailed protocols for using the kit, trouble-shooting, references, technical support, and any other related documents. Instructions can be supplied with the kit or as a separate member component, either as a paper form or an electronic form which may be supplied on computer readable memory device or downloaded from an internet website, or as recorded presentation. Instructions can include one or multiple documents and are meant to include future updates.

### Adaptive Polymer System (APS)

Illustrative embodiments are now discussed to demonstrate the technical features and compositions of the Adaptive Polymer System (APS). Other embodiments may be used in addition or instead. Details which may be apparent or unnecessary may be omitted to save space or for a more effective presentation. Conversely, some embodiments may be practices without all of the details which are disclosed.

The APS is a polymer system comprised of various monomers in a range of compositions and architectures.

In certain aspects, the APS can be blend of two or more different polymers. For example, the composition can include a mixture of a first thermoresponsive polymer and a second thermoresponsive polymer, where each is different.

In certain aspects, the APS includes one or more copolymers as described herein. A copolymer is a polymer having two or more different types of monomers joined in the same polymer chain. In certain embodiments, the APS comprises a block copolymer. Block copolymers are made up of blocks of different polymerized monomers. In certain aspects, the APS herein comprises a random copolymer. Random copolymers are made up of repeating units that are dispersed irregularly along the linear chains. In certain aspects, the APS herein comprises cross-linked copolymers.

Environmental stimuli that may cause a change in the APS include, but are not limited to, temperature, light, pH, sound, presence of a specific excipient, presence of a specific biological molecule or material, mechanical force, electric fields, and magnetic fields.

In certain aspects the APS is a thermoresponsive polymer. Thermoresponsive polymers are polymers that exhibit a change of their physical properties with temperature. Depending upon the thermoresponsive polymer, a drastic change to its physical properties can occur with a change of environmental temperature. In some aspects, a thermoresponsive polymer exhibits a volume phase transition at a certain temperature. In other aspects, a change in supermolecular architecture, color, miscibility, or other material property can be exhibited. This transition can be reversible or irreversible. Reversal to the original condition may also be gated by specific durations or environmental conditions.

In response to such environmental stimuli, the APS may undergo one or more changes in physical or chemical properties. In some embodiments this change can affect toughness, cohesiveness, adhesiveness, color, opacity, conductivity, or solubility. Similarly, a formulation including the APS may undergo these changes.

The APS can have one or more trigger points at which changes occur. These trigger points may concern the same or a different environmental stimulus. These trigger points may also concern the same or different type of change in material property. For example, the APS may undergo an increase in cohesion at one trigger point because of a change in temperature, and an increase in adhesion at another due to a change in local pH.

In certain aspects the APS comprises a responsive monomer and two or more weighting monomers which impact the trigger point. These weighting monomers can have raising or lowering effects on the trigger point or amplifying effects that alter the severity or duration of the change in APS or formulation properties.

In certain aspects, the APS can be crosslinked but only to an extent that their environmentally sensitive properties are not lost. In other aspects, cross-linking is intentionally performed to inhibit environmental sensitivity. In other aspects, multiple APS polymers can be a mixture of crosslinked and linear chains that allow for a balancing of properties.

In one embodiment, the APS is a copolymer comprising at least one residue from the monomers in Group (a), Group (b), and Group (c):
(a) a C₁-C₄ N-alkyl acrylamide, a C₁-C₄ N,N-dialkyl acrylamide, or a combination thereof;
(b) a C₁-C₁₈ alkyl acrylate, a C₁-C₁₈ alkyl methacrylate, or a combination thereof; and
(c) a hydrophilic monomer.

In certain embodiments, the APS is at least partly composed of a monomer or monomers which enable thermoresponsive, pH-responsive, light-responsive, or other stimulus-induced change in properties (Group A).

In certain embodiments the group A monomer is selected from n-isopropylacrylamide, N-propylacrylamide, N-propylmethacrylamide, N-ethoxyethylacrylamide, N-tetrahydrofurfurylacrylamide, N-tetrahydrofurfurylmethacrylamide, N,N-diethylacrylamide, N-isopropylmethacrylamide, N-tert-butylacrylamide, N-ethylacrylamide, N-cyclopropylacrylamide, N-cyclopropylmethacrylamide, N,N-dimethylacrylamide, N,N-diethylacrylamide, N-ethylacrylamide, or any combination thereof.

In certain embodiments the APS composition includes an additional monomer or group of monomers that decreases solvent affinity and thereby a gelation point (Group B).

In certain embodiments Group B monomers are selected from alkyl acrylates and alkyl methacrylates.

In certain aspects, Group B monomers are one or more C₁-C₁₈ alkyl acrylate. Examples of alkyl acrylates include, but are not limited to, methyl acrylate, ethyl acrylate, propyl acrylate, butyl acrylate, pentyl acrylate, hexyl acrylate, 2-ethylhexyl acrylate, styrene acrylate, heptyl acrylate, octyl acrylate, nonyl acrylate, decyl acrylate, undecyl acrylate, dodecyl acrylate, hexadecyl acrylate, stearyl acrylate, lauryl acrylate, t-butyl acrylate, isobutyl acrylate, isobornyl acrylate and any combination thereof.

In certain aspects, Group B monomers are one or more C₁-C₁₈ alkyl methacrylate. Examples of alkyl methacrylates include, but are not limited to, methyl methacrylate, ethyl methacrylate, propyl methacrylate, butyl methacrylate, pentyl methacrylate, hexyl methacrylate, 2-ethylhexyl methacrylate, styrene methacrylate, heptyl methacrylate, octyl methacrylate, nonyl methacrylate, decyl methacrylate, undecyl methacrylate, dodecyl methacrylate, hexadecyl methacrylate, stearyl methacrylate, lauryl methacrylate, t-butyl methacrylate, isobutyl methacrylate, isobornyl methacrylate and any combination thereof.

In some embodiments the incorporation of Group B monomers into the APS decreases a Top in a solvent, resulting in gelation at lower temperatures than if the Group B monomer were excluded from the structure.

In some embodiments the incorporation of a type B monomer improves the durability of the APS. As a hydrogel this may be observed as a more cohesive gel state above a Tcp. One possible mechanism is that the alkyl chains entangle or cluster, causing greater cohesion. Longer chain alkyl groups can further cause swelling in the solvent, resulting in higher viscosity below a Tcp, and a more solid form above Tcp.

In certain embodiments with long alkyl chains, swelling in certain solvents has been observed that suggests the chains associate and act like non-covalent cross-linkers.

In certain embodiments, the APS composition includes an additional hydrophilic monomer group which improves its solubility in a chosen solvent system (Group C). Incorporation of this monomer preserves or raises its Tcp. This effect can be desirable to achieve certain environmental trigger points above the region exhibited by a homopolymer or a copolymer. This effect may also be desirable to counteract effects of a Group B monomer, interacting formulation components, or the impacts of additional polymeric constituents.

In certain embodiments, Group C monomers include monomers that are polar, charged, or contain groups which readily promote solubility (e.g., promote solubility in water or other polar solvents). Examples include acrylamide, acrylic acid, hydroxyalkyl acrylates like hydroxyethyl acrylate or carboxyethyl acrylate, halogenated acrylates like 2-bromoethyl acrylate, vinyl alcohol, halogenated vinyl, hydroxyalkyl vinyl sulfide, N-(3-methoxypropyl) acrylamide, acrylic acid, N-hydroxyethyl acrylamide, methylenesuccinic acid, N-acryloxysuccinimide and other acrylic acids, maleic anhydride, methyl vinyl ether, and vinyl ether.

In certain embodiments, Group C monomers are charged, ionic or a polymerizable ionic liquid such as tetrabutylammonium acrylate, tetrabutylammonium styrene sulfonate, 2-acrylamido-2-methyl-1-propanesulfonic acid, 3-[(3-acrylamidopropyl) dimethylammonio] propanoate, 3-methyl-1-vinyl-1H-imidazol-3-ium methyl sulfate, [(2-acrylate)ethyl dimethylammonium acrylate, (2-acrylate) ethyl dimethylammonium methacrylate (2AEDMAM), tributyl-(4-vinylbenzyl)ammonium sulfopropyl acrylate, trihexyl-(4-vinylbenzyl)ammonium sulfopropyl acrylate, or any combination thereof. In another aspect, Group C is an acrylate or methacrylate with a dialkylimidazolium group, an alkylpyridinium group, or a tetraalkylammonium group.

In certain embodiments, the APS or Group C monomers incorporate one of the structures already described but is modified with additional basic functional groups. These functional groups are selected from hydroxy, carbonyl, carboxyl, amino, phosphate, lactone and sulfhydryl groups. In some embodiments, these functional groups incorporate alkyl chains as in the example of dimethylaminoethyl acrylate.

Monomers additional to the primary environmentally responsive monomer may contribute additional environmental sensitivity beyond a primary modality. For instance, incorporation of acidic monomers like acrylic acid can also lead to behavior around a trigger point that is influence by two variables (i.e., temperature and pH).

In certain water-based embodiments, the APS incorporates N-isopropyl acrylamide, an alkyl acrylate or methacrylate, and a polar, acidic, or basic monomer. The primary monomer (Group A) contributes its unique temperature-mediated gelation behavior. The second monomer (Group B) lowers the gelation point relative to a homopolymer of the primary while often improving the material properties like cohesion or flexibility. The third monomer (Group C) further alters polymer-solvent interaction, raising the gelation point relative to binary copolymer of the first and second monomers. The second and third monomers can also imbue the tertiary system with pH-sensitive changes in gelation behavior, improved adhesion, increased hardness, increased flexibility, or other material properties. The combination of these three compositional elements allows for precise targeting of smart hydrogel material properties and temperature-mediated gelation.

In certain embodiments, a strengthening monomer (Group D) is added to the APS to improve material properties of the hydrogel. This monomer may be used to change the swelling behavior below a gelation point, improve solubility in a solvent system, improve durability above the gelation point, control release of a bound, entangled, or encapsulated active ingredient, alter the gelation temperature, or imbue the APS with an additional environmental sensitivity.

In certain embodiments, this strengthening monomer is an alkyl methacrylate or alkyl acrylamide.

In certain embodiments this strengthening monomer is selected from maleic anhydride, methyl methacryate, methyl viny ether, ethyl acrylate, methyl acrylate, acrylonitrile, or ethylene.

In certain embodiments, this strengthening monomer is a cross-linker. These monomers have two or more vinyl functional groups that allow the linking of multiple polymer chains. Glycol diacrylates, other diacrylates, and bisacrylamides are examples of some linking monomers used. In some embodiments these monomers are comprised of polyethyleneglycol diacrylate, bisacrylamide and methylene bisacrylamide.

In certain embodiments, this strengthening monomer is a multifunctional acrylate or methacrylate. In certain embodiments these monomers include 1,1,1-Trimethylolpropane triacrylate, 1,1,1-trimethylolpropane trimethacrylate, pentaerythritol tetraacrylate, and dipentaerythritol pentaacrylate.

In certain embodiments, this strengthening monomer is an additional monomer from those groups already listed.

In certain embodiments, the selected monomers have unique encapsulation behavior suited to storage and controlled release of pharmaceuticals and other therapeutic compounds.

In certain embodiments, an additional monomer is added to the structure which is enables storage and controlled release of pharmaceuticals or other excipients (Group E).

In certain embodiments, the additional monomer binds or sequesters an excipient for later release. In certain embodiments the monomer includes a binding region such as 1) arylsulfate, disulfide or peptide—cleavable by enzyme, 2) hydrazone or acetyl—cleavable by acid, 3) disulfide—cleavable by glutathione, 4) nitrobenzyl or coumarin—cleavable by light, 5) azide—alkyne or thiolene-cleavable by click chemistry, 6) maleimide—hydrolysis or glutathione or alternate reducing agent.

In certain embodiments, the APS comprises NIPAM, one or more hydrophobic or hydrophilic monomers, and a monomer that promotes polymer degradation. In certain embodiments a monomer that promotes polymer degradation is selected from the group consisting of itaconic acid, succinic acid, hyaluronic acid, citric acid, and salicylic acid.

In certain embodiments, the properties of the APS hydrogel can be tailored by increasing the molecular weight of the polymer or polymers used. In some embodiments, a cross-linker may be used to achieve a higher molecular weight.

In certain embodiments, the APS has undergone radiation-induced cross-linking. In certain embodiments, this irradiation is accomplished by gamma irradiation. In others, it is accomplished by e-beam.

The APS can have a variety of compositions depending on the desired properties. For example, the Group A monomer can impart environmental response. In certain embodiments the Group A monomer is the majority monomer, occupying a higher mol percent of the polymer composition than any other groups respectively. In certain other embodiments the Group A monomer is from 50 mole % to 99 mole % of the APS. In certain embodiments, Group B and C monomers occupy up to 30 mole % of the polymer composition respectively. In certain embodiments, group D monomers occupy up to 25 mole % of the polymer composition by mol percent. In certain other embodiments using cross-linkers, the linking monomer occupies up to 10 mole % of the polymer composition by mol percent.

In one aspect, the residue from Group (a) is from about 50 mole percent to about 99 mole percent of the copolymer, is from about 50 mole percent, 60 mole percent, 70 mole percent, 80 mole percent, 90 mole percent, 95 mole percent, or 99 mole percent, where any value can be a lower and upper endpoint of a range (e.g., 60 mole percent to 90 mole percent).

In one aspect, the residue from Group (b) is from about 0.5 mole percent to about 20 mole percent of the copolymer, is from about 0.5 mole percent, 1 mole percent, 5 mole percent, 10 mole percent, 15 mole percent, or 20 mole percent, where any value can be a lower and upper endpoint of a range (e.g., 5 mole percent to 15 mole percent).

In one aspect, the residue from Group (c) is from about 1 mole percent to about 30 mole percent of the copolymer, is from about 1 mole percent, 5 mole percent, 10 mole percent, 15 mole percent, 20 mole percent, 25 mole percent, or 30 mole percent, where any value can be a lower and upper endpoint of a range (e.g., 5 mole percent to 15 mole percent).

In an APS consisting of multiple polymers, ratios of compositional elements may or may not be held constant. For example, to achieve unique formulation properties, compositional ratios may be retained but polymers with different average molecular weights incorporated. As another example, two polymers with entirely different compositional elements may be used to facilitate multiple environmental responses.

APS polymer architecture can vary. In certain embodiments the structure is selected from random, block, comb, alternating, or graft.

The properties of the APS are designed around one or more trigger points. In certain aspects, a trigger point is from about 5° C. to about 80° C., or about 25° C., about 28° C., about 32° C., about 34° C., about 36° C., about 37° C., about 40° C., about 50° C., about 60° C., about 70° C., about 80° C., where any value can be a lower and upper endpoint of a range (e.g., about 18° C. to about 32° C., about 25° C. to about 36° C., etc.). In certain aspects, the trigger point is centered around physiological body temperature.

In some embodiments the APS is formulated in a hydrogel with a Tcp from about 10° C. to about 32° C., wherein the relative effect of the monomer containing hydrophobic regions outweighs the effect of the third component.

In some embodiments the APS is formulated in a hydrogel with a Tcp from about 32° C. to about 55° C., wherein the relative effect of the monomer containing hydrophilic regions outweighs the effect of the third component.

In certain embodiments, the APS contains NIPAM, butyl acrylate, and acrylamide. In certain embodiments, the relative amounts of the three monomers allow the APS to take on a wide range of phase change behaviors and material properties.

The balancing effects of APS components on the trigger point of APS-based formulations can be modified. As demonstrated in the Examples, it can be observed that as the relative portion of alkyl acrylate in the polymer increases, the Tcp trigger point lowers. At the same time, if a hydrophilic group is added, it can counterbalance these effects.

The APS described herein can include one or more polymers. In one aspect, the APS compositions include one or more copolymers. A copolymer is a polymer having two or more different types of monomers joined in the same polymer chain. In certain embodiments, a composition herein comprises a block copolymer. Block copolymers are made up of blocks of different polymerized monomers. In certain aspects, the topical composition herein comprises a random copolymer. Random copolymers are made up of repeating units that are dispersed irregularly along the linear chains. In certain aspects, the topical composition herein comprises cross-linked copolymers. Cross-linked copolymers are polymers that are linked to one another by covalent or ionic or hydrogen bonds.

The copolymers used in the coatings are prepared using several polymerization techniques including atom transfer radical polymerization, reversible addition fragmentation chain transfer, and free radical polymerization. Nonlimiting procedures making the copolymers are provided in the Examples.

### APS Formulations

Formulations incorporating an APS may be used for a variety of medical or consumer applications. To achieve certain applications, combinations of APS polymers with various solvents and excipients is necessary.

The APS is also uniquely suited to designing environmentally responsive formulations as it allows for tailoring of material properties around a specific environmental trigger point. In certain embodiments the effects of added excipients which would otherwise shift the trigger point or material properties can be counterbalanced using the monomer groups previously described.

The amount of the APS present in a formulation can vary. In certain aspects, the APS polymer is present in an amount from about 1% to about 60% by weight based upon a total weight of the composition. In another aspect, the APS polymer is present in an amount from about 1%, about 5%, about 10%, about 15%, about 20%, about 25%, about 30%, about 35%, about 40%, about 45%, about 50%, about 55%, or about 60% by weight based upon a total weight of the composition, where any value can be a lower and upper endpoint of a range (e.g., about 20% to about 50%, about 30% to about 40%, etc.).

### Solvents

In certain aspects, the APS is formulated with a solvent. In certain embodiments, the solvent serves as a delivery vehicle. In other embodiments, the solvent enables a unique smart behavior and is present in some form or amount when an APS formulation is used.

In one aspect, the solvent is a polar organic solvent, water, or a combination thereof. In another aspect, the solvent is mid-polar organic solvent such as, for example, an alcohol including but not limited to ethyl alcohol, methyl alcohol, isopropanol, sec-butanol, n-butanol, iso-butanol, 1-methoxy-2 propanol, diacetone alcohol, texanol. Examples of polar organic solvents include, but are not limited to, anisole, toluene, xylene, methyl ethyl ketone, DMSO, THF, acetone, hexane, heptane, cyclohexane, MTBE or an organic alkyl acetate such as ethyl acetate, or any combination thereof.

In certain aspects, a combination of two or more solvents can be used to modify an environmentally sensitive behavior or material property—the co-solvent effect. For example, a hydrogel consisting of NIPAM-containing APS and water would generally have a higher Tcp in pure water than if a competitive solvent were added (e.g., ethanol).

In another aspect, the solvent includes a secondary solvent such as, for example, diacetone alcohol, 1-methoxy-2-propanol, simple diols like propylene and pentylene glycol, simple triols glycerin, propylene carbonate, dimethyl glutarate, dimethyl adipate, methyl soyate, and 2,2,4-trimethyl-1,3-pentanediol monoisobutyrate.

In certain aspects, a viable solvent concentration is tied to polymer swelling, molecular weight, and polymer composition, but a higher concentration will generally result in a more viscous liquid phase.

In some embodiments an APS hydrogel is formed by formulating with water.

In some embodiments APS hydrogels exhibit temperature-induced changes in solubility, resulting in changes in material properties around a Tcp.

In some aspects, the APS can be added to water to form a hydrogel that becomes hydrophobic and undergoes chain collapsing at or exceeding its trigger point while remaining hydrophilic and undergoing chain expansion at a below its trigger point.

In certain aspect, the solvent is from about 40 weight percent to about 90 weight percent of the APS formulation. In another aspect, the solvent is from about 40 weight percent, about 45 weight percent, about 50 weight percent, about 55 weight percent, about 60 weight percent, about 65 weight percent, about 70 weight percent, about 75 weight percent, about 80 weight percent, about 85 weight percent, or about 90 weight percent of the APS formulation, where any value can be a lower and upper endpoint of a range (e.g., 45 weight percent to 75 weight percent).

In certain aspects, water in an APS formulation is from about 40% to about 90% by weight based upon a total weight of the composition. In another aspect, the aqueous carrier is from about 40%, about 45%, about 50%, about 55%, about 60%, about 65%, about 70%, about 75%, about 80%, about 85%, or about 90% by weight based upon a total weight of the composition, where any value can be a lower and upper endpoint of a range (e.g., about 50% to about 90%, about 60% to about 80%, etc.).

### Secondary Polymers

In certain aspects, APS formulations benefit from incorporation of one or more secondary polymers. Secondary polymers can provide additional material properties or behaviors such as, for example, strength, flexibility, gloss, hardness, differences in environmental response, or impacts on formulation characteristics like solubility.

In certain aspects the secondary polymer is a cellulose ester, wherein the cellulose ester comprises cellulose acetate butyrate, nitrocellulose, cellulose acetate propionate, cellulose acetate phthalate, hydroxypropyl cellulose, hydroxyethyl cellulose, or any combination thereof. In certain aspects the polymer is an alkylated cellulose such as methyl cellulose or ethyl cellulose. Each of these cellulose forms can be purchased or manufactured in a range of molecular weights and constituent ratios. In one aspect, the inclusion of the cellulose ester in the APS formulation can provide additional gloss and strength to the resulting film.

In one aspect, the secondary polymer is a polyester, an alkyd, a polyurethane, a tosylamide formaldehyde resin, an acrylic resin, vinyl acetate/butyl maleate/IBA copolymer, imidized isobutylene/maleic anhydride copolymer, polyvinyl methyl ether/maleic acid copolymer, a cellulose ester, a rosinate, or any combination thereof.

In another aspect, other secondary polymers can improve the strength of a formula that are not of the vinyl and cellulose ester categories. These include polyesters, polyurethanes, polysiloxanes, silicones. Examples include poly(adipic acid/neopentyl glycol/trimellitic anhydride), poly (hexylene glycol/neopentyl glycol/adipic acid, saturated methylene diphenyldiisocyanate/dimethylolpropionic acid), amodimethicone, and dimethicone.

In certain embodiments, the secondary polymer is capable of forming a hydrogel or dissolving in water and is selected from polyethylene glycol, polyvinyl alcohol, polyacrylamide, alginate, chitosan, hyaluronic acid, gelatin, polyvinyl pyrrolidone, polyglycolic acid, polylactic acid, polydioxanone, caprolactone, polyvinyl caprolactone, polyglyconate, collagen, and fibrin.

In certain other aspects, the secondary polymer is a vinyl polymer formed from acrylic monomers.

In one aspect, the secondary polymer is from about 0.2 weight percent to about 20 weight percent of the APS formulation. In another aspect, the secondary polymer is about 0.2 weight percent, about 5% about 10 weight percent, about 15 weight percent, or about 20 weight percent of the APS formulation, where any value can be a lower and upper endpoint of a range (e.g., 6 weight percent to 12 weight percent). In other embodiments the secondary polymer is 30-55 weight percent of the APS formulation.

### Additives

The APS formulations described herein include one or more additives. The additives can modify physical properties, chemical properties, or health benefits of the formulations. In one aspect, the when the APS formulation is for topical use, the additive can include a polymer, ceramics, metals, salt, a rheology modifier, a suspension agent, a dispersant, a wetting agent, a low vapor pressure solvent, a plasticizer, pigments, effect powders, fragrance, an antimicrobial agent, an emollient, an emulsifier, a solubilizer, a humectant, a stabilizer, an exfoliant, a lipid or oil, a vitamin, a biological molecule, an essential oil, a fragrance, a drug carrier, a preservative, a thickener, color additive, pH adjuster, a surfactant, a pharmaceutical, an adhesion promoter, or any combination thereof.

In certain embodiments ceramic materials are incorporated into APS formulations. In some embodiments these material are selected from alumina, zirconia, hydroxyapatite, kaolin, bentonite, silica, feldspar, sand, or a combination thereof.

In certain embodiments, metals are incorporated into APS formulations. In some embodiments these are selected from stainless steel, copper, aluminum, titanium, cobalt-chrome, zinc, or a combination thereof.

When the APS formulation needs a desired color or appearance, one or more pigments are incorporated into the APS formulation. Examples of pigments include, but are not limited to, 3158TPLitholRubine BK, Carbon black N330, Degussa Printex, Titanium dioxide, D&C Brown No 1, D&C Black No 2, D&C Black No 3, 1104 Fast Yellow, 1283 Permanent Yellow HR, 1646 Medium Chrome yellow, FD&C Yellow No 5, D&C Yellow No 5 lake, D&C Yellow No 6 lake, D&C Yellow No 7 lake, D&C Yellow No 8, D&C Yellow No 10, D&C Yellow No 11, 3157 Vulcan Red LC, FD&C Red 3 lake, FD&C Red 4 lake, D&C Red No 4 aluminium lake, D&C Red No 6 aluminium lake, D&C Red No 6 barium lake, D&C Red No 7 lake, D&C Red No 8 lake, D&C Red No 9 lake, D&C Red No 17, D&C Red No 21, D&C Red No 22, D&C Red No 27 lake, D&C Red No 28, D&C red No 30 lake, D&C Red No 31, D&C Red No 33 lake, D&C red No 34 lake, D&C Red No 36 lake, FD&C Red No 40, 4421 Phthalocyanine Blue B pigment, 4431 Phthalocyanine Blue BS pigment, 4311 Pigment Sky Blue B, FD&C Blue 1 lake, D&C Blue No 4, 5319 Fast Green lake pigment, 5406 Phthalocyanine Green G pigment, 3327 Basic Rhodamine BG Lake pigment, FD&C Green No 3, D&C Green No 3 lake, D&C Green No 5, D&C Green No 6, D&C Green No 8, 6360 Fast Violet lake pigment, D&C Violet No 2, D&C Orange No 4 lake, D&C Orange No 5 aluminium lake, D&C Orange No 5 zirconium lake, D&C Orange No 10 aluminium lake, D&C Orange No 11, D&C Orange No 17 lake, Iron oxides of various shades, manganese violet, silver nitrate, ultramarines, zinc oxide, ferric ammonium ferrocyanide, ferric ferrocyanide, aluminum powder, bismuth oxychloride, copper powder, chromium hydroxide green, chromium oxide green, silver, Mica, or a combination thereof.

In other aspects, additional effect pigments are included such as micas, pearls, glitter, metal flakes glass, additional pigment or a combination thereof.

In one aspect, the pigment is from about 0.5 weight percent about 10% of the total weight APS formulation. In another aspect, the pigment is from about 0.5 weight percent, about 1 weight percent, about 2 weight percent, about 3 weight percent, about 4 weight percent, about 5 weight percent, about 6 weight percent, about 7 weight percent, about 8 weight percent, about 9 weight percent, or about 10 weight percent of the APS formulation, where any value can be a lower and upper endpoint of a range (e.g., 3 weight percent to 7 weight percent).

In one aspect, rheology modifiers can be used to alter formulation material properties. In one aspect, a filler such as, for example, hectorite, stearalkonium hectorite, bentonite, bentonite, stearalkonium bentonite, silica, hydrophobic fumed silica, hydrophilic fumed silica, silica dimethyl silylate, organophilic phyllosilicate, kaolin clay, nanoclay, halloysite, montmorillonite, or any combination thereof can be used.

In one aspect, the filler is from about 0.5 weight percent about 10% of the total weight APS formulation. In another aspect, the filler is from about 0.5 weight percent, about 1 weight percent, about 2 weight percent, about 3 weight percent, about 4 weight percent, about 5 weight percent, about 6 weight percent, about 7 weight percent, about 8 weight percent, about 9 weight percent, or about 10 weight percent of the APS formulation, where any value can be a lower and upper endpoint of a range (e.g., 3 weight percent to 7 weight percent).

In other aspects, a high amount of filler is used at weight percents of 30-60% by mass of the total formulation composition.

In certain aspects, dispersants and wetting agents are used to improve the uniformity of formulations and prevent aggregation. Examples include, but not limited to, glycols, surfactants, ethoxylated alcohols, polymeric wetting agents like ethylene oxide-propylene oxide block copolymers, and silicones. In some embodiments the wetting agent in the formulations is styrene/acrylates copolymer, acrylic block copolymer, ethylene oxide/propylene oxide block copolymer, stearic acid, jojoba esters, glycerol, propylene glycol, ethylene glycol, lactonic sophorolipid, cocoamido propyl dimethyl amine, alpha-arbutin, cocamidopropylamine oxide, 2-octyldodecyl 2-ethylhexanoate, 1, 2, 3-trilinolenoylglycerol, cyclopentanecarboxylic acid sodium lauryl sulfate, octyl phenol ethoxylate, polysorbate 20, dimethicone, amodimethicone, or any combination thereof.

In certain aspects, low vapor pressure solvents are used to improve the formulation durability, act as coalescing agents, provide shrink resistance, promotes solubility of certain formulation excipients or alter the quality of application of the APS formulation. Examples include, but not limited to, propylene carbonate, dimethyl glutarate, dimethyl adipate, methyl soyate, 2,2,4-trimethyl-1,3-pentanediol monoisobutyrate, dimethyl sulfoxide, or a combination thereof.

In certain aspects, plasticizers are incorporated to improve the flexibility, smoothness, lubricity, or crack resistance of the formulation. Examples include, but not limited to, acetyl tributyl citrate, tributyl citrate, triethyl citrate, dimethyl adipate, glycerin propylene glycol, ethylene glycol monoricinoleate, 2,2,4-trimethyl-1,3-pentanediol monoisobutyrate, bis(2-ethylhexyl) sebacate, diisopropyl sebacate, tridodecyl phosphate, dimethyl adipate, lavender essential oil, jojoba oil, argan oil, essential oils, plant oils, or a combination thereof. Some surfactants, resins, and other ingredients listed elsewhere in this disclosure with low vapor pressure are also suitable as plasticizers.

In one aspect, an additive is an anti-microbial agent including, but not limited to, tetrasodium EDTA, disodium EDTA, phenoxyethanol, diazolidinyl urea, iodopropynyl butylcarbamate, Lactobacillus & Cocos nucifera (coconut) fruit extract, Leuconostoc ferment filtrate, benzyl alcohol, salicylic acid, glycerin, sorbic acid, gluconolactone, Sorbus aucuparia fruit ferment filtrate, capryl glycol, Sambucus nigra fruit extract, or any combination thereof.

In one aspect, the additive is an emollient including, but not limited to, shea butter, cocoa butter, mineral oil, lanolin, petrolatum, paraffin, beeswax, squalene, coconut, jojoba, sesame, avocado, argan, jojoba, almond, castor, and other plant oils (hydrogenated or unhydrogenated), cetyl alcohol, olive oil (e.g., oleic acid), triethylhexanoin, copernicia cerifera wax, lauryl laurate, capric triglyceride, cetearyl alcohol, alkyl benzoate, glyceryl stearate, coceth-20, glycerin, hydroxyetheyl cellulose, potassium sorbate, sodium phytate, citric acid, Lactobacillus ferment, behenyl alcohol, Nereocystis luetkeana ferment filtrate, hydrogenated polyisobutene, or any combination thereof.

In one aspect, the additive is an emulsifier including, but not limited to, cetearyl alcohol, glyceryl stearate, sodium stearoyl lactylate, PEG-100 stearate, behentrimonium methosulfate, polysorbate, sodium acrylate, isohexadecane, acacia gum, PEG, PEG-7 glyceryl monococoate, PEG-40 hydrogenated castor oil, PEG distearate, sorbitan laurate, polyglyceryl laurate, dilauryl citrate, caprylic triglyceride, cetearyth-n, sodium polyacrylate, ehthylhexyl cocoate, PPG-3 Benzyl ether myristate, or any combination thereof.

In one aspect, the additive is a solubilizer including, but not limited to, capryl glucoside, ethoxydiglycol, sodium cocoyl glutamate, glyceryl caprylate, polyglyceryl-6 oleate, sodium surfactin, D-glucopyranose, decyl octyl glycosides, polyglyceryl caprylate, polyglyceryl caprate, polyglyceryl cocoate, polyglyceryl ricinoleate, or any combination thereof.

In one aspect, the additive is a humectant including, but not limited to, propanediol, butylene glycol, ethoxy diglycol, ethylhexyl glycerin, pentylene glycol, propylene glycol, silica gel, PPG-20 methyl glucose ether, glycerin, malic acid, honey, honey powder, or any combination thereof.

In one aspect, the additive is a stabilizer including, but not limited to, xanthum gum, glucose oxidase, sclerotium gum, behenyl alcohol, cetyl alcohol, candellia wax, arrowroot powder, plant wax, sorbitan olivate, or any combination thereof.

In one aspect, the additive is an exfoliant including, but not limited to, salicylic acid, citric acid, glycolic acid, urea, plant powders, plant acids, glucosamine, plant extracts, enzymatic products of bacterial fermentation, or any combination thereof.

In one aspect, the additive is a binder selected from acrylic polymers, alkyds, polyurethanes, vinyl acetate, epoxy, polyvinyl chloride, latex, chitosan, casein, rubber acrylic resins, or combinations thereof.

In one aspect, the additive is a lipid or oil including, but not limited to, ceramides, blueberry seed oil, acacia seed oil, algae oil, almond oil, black currant extract, blackberry seed oil, borrage oil, jasmine oil, pomegranate seed oil, raspberry seed oil, other plants oils and extracts, cholesterol, phospholipids, linoleic acid, or combinations thereof.

In one aspect, the additive is a peptide, pre-peptide, or other biological molecule including, but not limited to, collagen pre-peptide, collagen, palmitoyl pentapeptide-4, palmitoyl oligopeptide, palmitoyl tetrapeptide-7, ferment peptide extracts, or plant extract derived peptides.

In one aspect, the additive is a surfactant. In another aspect, the surfactant is a nonionic surfactant. Examples of nonionic surfactants include the condensation products of a higher aliphatic alcohol, such as a fatty alcohol, containing about 8 to about 20 carbon atoms, in a straight or branched chain configuration, condensed with about 3 to about 100 moles, preferably about 5 to about 40 moles, most preferably about 5 to about 20 moles of ethylene oxide. Examples of such nonionic ethoxylated fatty alcohol surfactants are the Tergitol™ 15-S series from Union Carbide and Brij™ surfactants from ICI. Tergitol™ 15-S Surfactants include C11-C15 secondary alcohol polyethyleneglycol ethers. Brij™ 97 surfactant is polyoxyethylene (10) oleyl ether; Brij™ 58 surfactant is polyoxyethylene (20) cetyl ether; and Brij™ 76 surfactant is polyoxyethylene (10) stearyl ether.

Another useful class of nonionic surfactants include the polyethylene oxide condensates of one mole of alkyl phenol containing from about 6 to 12 carbon atoms in a straight or branched chain configuration, with ethylene oxide. Examples of nonreactive nonionic surfactants are the Igepal™ CO and CA series from Rhone-Poulenc. Igepal™ CO surfactants include nonylphenoxy poly(ethyleneoxy)ethanols. Igepal™ CA surfactants include octylphenoxy poly(ethyleneoxy)ethanols.

Another useful class of hydrocarbon nonionic surfactants include block copolymers of ethylene oxide and propylene oxide or butylene oxide. Examples of such nonionic block copolymer surfactants are the Pluronic™ and Tetronic™ series of surfactants from BASF. Pluronic™ surfactants include ethylene oxide-propylene oxide block copolymers. Tetronic™ surfactants include ethylene oxide-propylene oxide block copolymers.

In other aspects, the nonionic surfactants include sorbitan fatty acid esters, polyoxyethylene sorbitan fatty acid esters and polyoxyethylene stearates. Examples of such fatty acid ester nonionic surfactants are the Span™, Tween™, and Myj™ surfactants from ICI. Span™ surfactants include C12-C18 sorbitan monoesters. Tween™ surfactants include poly(ethylene oxide) C12-C18 sorbitan monoesters. Myj™ surfactants include poly(ethylene oxide) stearates.

In one aspect, the nonionic surfactant can include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ether, polyoxyethylene cetyl ether, polyoxyethylene stearyl ether, polyoxyethylene oleyl ether, polyoxyethylene octylphenyl ether, polyoxyethylene nonylphenyl ether, polyethylene glycol laurate, polyethylene glycol stearate, polyethylene glycol distearate, polyethylene glycol oleate, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurate, polyoxyethylene sorbitan stearate, polyoxyethylene sorbitan oleate, polyoxyethylene laurylamine, polyoxyethylene laurylamide, laurylamine acetate, hard beef tallow propylenediamine dioleate, ethoxylated tetramethyldecynediol, fluoroaliphatic polymeric ester, polyether-polysiloxane copolymer, and the like.

In one aspect, a pH adjuster is included in the APS formulations described herein. Examples include, but are not limited to, citric acid, sodium bicarbonate, alkyl siliconates, magnesium hydroxide, triethanolamine, ammonia, aminomethyl-propanol, sugar-amines, protonated sugar amines, or combinations thereof.

In one aspect a color protectant is included in the APS formulations described herein. Examples include, but are not limited to, hydroxyphenyl benzotriazoles, butanedioic acid dimethylester polymer with 4-hydroxy-2,2,6,6-tetramethyl-1-piperidine ethanol, other oligomeric UV stabilizers, bisoctrizole, bemotrizinol, dimethyl (p-methoxybenzylidene) malonate, dioxybenzone, hindered amines, high molecular weight oligomeric hindered amines, assorted antioxidants, hydroxyacetophenone, butylated hydroxytoluene, butylated hydroxyanisole, vitamin E, other vitamins, plant extracts, green tea extract, rosemary extract, resveratrol, UV absorbers, benzophenone, ethylhexyl methoxycinnamate, ethylhexyl salicylate, avobenzone, homosalate, octocrylene, and combinations thereof.

In another aspect, the APS formulations described herein as well as other formulations (e.g., base formulation, protective formulation) discussed in greater detail below can include additional ingredients to improve the scent of the formulations. These include synthetic and natural fragrances. In some embodiments they include essential oils, agrumen, amber, ambergris, ambrette, amyris, benzoin, bergamot, calone, cashmeran, castoreum, citron, civet, clary sage, coumarin, frangipani, frankincense, galbanum, guaiac wood, hedione, heliotrope, iso e super, jasmine, jasmine sambac, labdanum, mimoa, monoi, muguet, musk, myrrh, narcissus, neroli, oakmoss, opopanax, orris, oud, ozone, patchouli, rose, rose de mai, sandalwood, tonka bean, tuberose, anilla, vetiver, ylang ylang, cedarwood, cardamom, lavender, tea tree, lemongrass, eucalyptus, hydrosol, plant water, or combination thereof.

In certain aspects, any of the formulations described herein can include synthetic fragrances, ethylvanillin, heliotropine, ionones, aldehydes, calone, ambrox, ethyl maltol, myristic acid, 2-furaldehyde, delta decalactone, delta dodecalactone, 2 methyl 2 pentenoic acid, 2,4 decadienal, 5 methyl 2 phenyl 2 hexenal, acetaldehyde, acetyl propionyl, anisyl, acpric acid, capoic acid, caprylic acid, cyclotene, methyl 3 nonenoate, ethyl 3 hydroxybutyrate, ethyl maltol, lactic acid, lauric acid, pulegone mercaptan, 4-(p-hydroxyphenyl)-2-butanone, 4-hydroxy-2,5-dimethyl-3(2H)-furanone, triethyl citrate, furanone, acetoin, 6-methyl coumarin, 4,5-dimethyl-3-hydroxy-2,5-dihydrofuran-2-one, 2,5 dimethyl 4-methoxy-3(2h)-furanone, 2-methoxy-4-methylphenol, 5-ethyl-3-hydroxy-4-methyl-2(5h)furanone, caproic acid methyl ester, oleic acid ethyl ester, methyl salicylate, 4-hydroxy pentanoic acid γ lactone, 5-ethyl-3-hydroxy-4-methyl-2(5h)furanone, 1,5,5,9-tetramethyl-13-oxatricyclo(8.3.0.0)tridecane, isobutyric acid maltol ester, diethyl succinate, phenyl ethyl isothiocyanatem, 4 hydroxy-5-methyl-3-(2h) furanone, 2-ethyl-5-methyl-4-hydroxy-3(2H)-furanone, dihydro coumarin, ethyl 3-hydroxy caproate, furanone acetate, glyceryl triacetate, 1-octen-3-ol, 3-hydroxy-2-butanone, popcorn pyrimidine, 4-hydroxy-2,5-dimethyl-3 (2H)-furanone, 5-methyl-2-hepten-4-one, 4-hydroxy-3methyl octanoic acid lactone, 2-buten-1-one, 1-(2,6,6 trimethyl-1,3cyclohexadien-1-yl, 3-cyclohexene-1carboxaldehyde, 2,4-dimethyl, butyl butyryl lactate, 1,2-di-[(1-ethoxy) ethoxy]propane, 4-(2,6,6-trimethyl cyclo-1-enyl) but-2-en-4-one, butanedioic acid, terpineol, 3-methyl-5-cyclopentadecen-1-one, 5-methyl-2-propan-2-ylhex-2-enal, related aromatic compounds, or any combination thereof.

In certain aspect, oils, vitamins, peptides, proteins, and other ingredients beneficial for health are incorporated into the formulations. In some embodiments these include alpha hydroxy acids, hyaluronic acid, retinol, salicylic acid, ceramides, sulfur, vitamin A, vitamin e, vitamin c, vitamin b, vitamin k, vitamin D, alpha-linolenic acid (ALA), eicosapentaenoic acid (EPA), and docosahexaenoic acid (DHA), calcium carbonate, calcium citrate, keratin, collagen, olive oil, rapeseed oil, jojoba oil, argan oil, essential oils, plant extracts, zinc gluconate, iron (II) sulfate, magnesium oxide, Phytosphingosine, tocopherol acetate, ashwagandha, curcumin, amino acids, peptides, piperine, chavicine, keratin, horsetail extract, amla extract, chamomile extract, sea buckthorn oil, sea buckthorn extract, centella asiatic extract, pin bark extract, plum extract, coffeeberry extract, and combinations thereof.

In certain aspects, the additive is a polymer including, but not limited to, hyaluronic acid, alginate, ethyl cellulose, polyvinyl alcohol, chitosan, poly-ethylene glycol, polyacrylic acid, dextran, hydroxyethylmethacrylate, lecithin, polysorbate, or combinations thereof.

In certain aspects, the additive is a salt including, but not limited to, NaCl, KCl, NaI, NaBr, Calcium Hydroxide, Calcium Carbonate, Sodium Bicarbonate, or any combination thereof.

In certain aspects, the additive is an anti-microbial agent including, but not limited to, tetrasodium EDTA, disodium EDTA, phenoxyethanol, diazolidinyl urea, iodopropynyl butylcarbamate, Lactobacillus & Cocos nucifera (coconut) fruit extract, Leuconostoc ferment filtrate, benzyl alcohol, salicylic acid, glycerin, sorbic acid, gluconolactone, Sorbus aucuparia fruit ferment filtrate, capryl glycol, Sambucus nigra fruit extract, or any combination thereof.

In certain aspects, the additive is a mineral or clay including, but not limited to, kaolin clay, bentonite clay, montmorillonite, or any combination thereof.

In certain aspects, the additive is an emollient including, but not limited to, shea butter, cocoa butter, mineral oil, lanolin, petrolatum, paraffin, beeswax, squalene, coconut, jojoba, sesame, avocado, argan, jojoba, almond, castor, and other plant oils (hydrogenated or unhydrogenated), cetyl alcohol, olive oil (e.g., oleic acid), triethylhexanoin, copernicia cerifera wax, lauryl laurate, capric triglyceride, cetearyl alcohol, alkyl benzoate, glyceryl stearate, coceth-20, glycerin, hydroxyetheyl cellulose, potassium sorbate, sodium phytate, citric acid, Lactobacillus ferment, behenyl alcohol, Nereocystis luetkeana ferment filtrate, hydrogenated polyisobutene, or any combination thereof.

In certain aspects, the additive is an emulsifier including, but not limited to, cetearyl alcohol, glyceryl stearate, sodium stearoyl lactylate, PEG-100 stearate, behentrimonium methosulfate, polysorbate, sodium acrylate, isohexadecane, acacia gum, PEG, PEG-7 glyceryl monococoate, PEG-40 hydrogenated castor oil, PEG distearate, sorbitan laurate, polyglyceryl laurate, dilauryl citrate, caprylic triglyceride, cetearyth-n, sodium polyacrylate, ehthylhexyl cocoate, PPG-3 Benzyl ether myristate, or any combination thereof.

In certain aspects, the additive is a solubilizer including, but not limited to, capryl glucoside, ethoxydiglycol, sodium cocoyl glutamate, glyceryl caprylate, polyglyceryl-6 oleate, sodium surfactin, D-glucopyranose, decyl octyl glycosides, polyglyceryl caprylate, polyglyceryl caprate, polyglyceryl cocoate, polyglyceryl ricinoleate, or any combination thereof.

In certain aspects, the additive is a humectant including, but not limited to, propanediol, butylene glycol, ethoxy diglycol, ethylhexyl glycerin, pentylene glycol, propylene glycol, silica gel, PPG-20 methyl glucose ether, glycerine, malic acid, honey, honey powder, or any combination thereof.

In certain aspects, the additive is a stabilizer including, but not limited to, xanthum gum, glucose oxidase, sclerotium gum, behenyl alcohol, cetyl alcohol, candellia wax, arrowroot powder, plant wax, sorbitan olivate, or any combination thereof.

In certain aspects, the additive is an exfoliant including, but not limited to, salicylic acid, citric acid, glycolic acid, urea, plant powders, plant acids, glucosamine, plant extracts, enzymatic products of bacterial fermentation, or any combination thereof.

In certain aspects, the additive is a lipid or oil including, but not limited to, ceramides, blueberry seed oil, acacia seed oil, algae oil, almond oil, black currant extract, blackberry seed oil, borrage oil, jasmine oil, pomegranate seed oil, raspberry seed oil, other plants oils and extracts, cholesterol, phospholipids, linoleic acid, or combinations thereof.

In certain aspects, the additive is a vitamin including, but not limited to, vitamin A, B, B3, B5, C, D, K, retinol, vitamin-like compounds therapeutic molecules, or any combination thereof.

In certain aspects, the additive is a peptide, pre-peptide, or other biological molecule including, but not limited to, collagen pre-peptide, collagen, palmitoyl pentapeptide-4, palmitoyl oligopeptide, palmitoyl tetrapeptide-7, ferment peptide extracts, chitosan, assorted polysaccharides, assorted peptides, or plant extract derived peptides.

In certain aspects, the additive is an essential oil, hydrosol, customized fragrance molecule, mixed fragrance, or any combination thereof.

In certain aspects, the additive is a thickener, a color additive, a pH adjuster, or any combinations thereof.

In certain aspects, the additive is a preservative including, but not limited to, trisodium edetate, tetrasodium edetate, tocopherol, butyl paraben, propyl paraben, ethyl paraben, methyl paraben, DMDM hydantoin, methylisothiazolinone, phenoxyethanol, quaternium-15, phenoxyethanol, benzoic acid, Sorbic acid, glycols, or any combination thereof.

In aspect, the additive is a surfactant. In another aspect, the surfactant is a nonionic surfactant. Examples of nonionic surfactants include the condensation products of a higher aliphatic alcohol, such as a fatty alcohol, containing about 8 to about 20 carbon atoms, in a straight or branched chain configuration, condensed with about 3 to about 100 moles, preferably about 5 to about 40 moles, most preferably about 5 to about 20 moles of ethylene oxide. Examples of such nonionic ethoxylated fatty alcohol surfactants are the Tergitol™ 15-S series from Union Carbide and Brij™ surfactants from ICI. Tergitol™ 15-S Surfactants include C₁₁-C₁₅ secondary alcohol polyethyleneglycol ethers. Brij™ 97 surfactant is polyoxyethylene (10) oleyl ether; Brij™ 58 surfactant is polyoxyethylene (20) cetyl ether; and Brij™ 76 surfactant is polyoxyethylene (10) stearyl ether.

Another useful class of nonionic surfactants include the polyethylene oxide condensates of one mole of alkyl phenol containing from about 6 to 12 carbon atoms in a straight or branched chain configuration, with ethylene oxide. Examples of nonreactive nonionic surfactants are the Igepal™ CO and CA series from Rhone-Poulenc. Igepal™ CO surfactants include nonylphenoxy poly(ethyleneoxy)ethanols. Igepal™ CA surfactants include octylphenoxy poly(ethyleneoxy)ethanols.

Another useful class of hydrocarbon nonionic surfactants include block copolymers of ethylene oxide and propylene oxide or butylene oxide. Examples of such nonionic block copolymer surfactants are the Pluronic™ and Tetronic™ series of surfactants from BASF. Pluronic™ surfactants include ethylene oxide-propylene oxide block copolymers. Tetronic™ surfactants include ethylene oxide-propylene oxide block copolymers.

In other aspects, the nonionic surfactants include sorbitan fatty acid esters, polyoxyethylene sorbitan fatty acid esters and polyoxyethylene stearates. Examples of such fatty acid ester nonionic surfactants are the Span™, Tween™, and Myj™ surfactants from ICI. Span™ surfactants include C₁₂-C₁₈ sorbitan monoesters. Tween™ surfactants include poly(ethylene oxide) C₁₂-C₁₈ sorbitan monoesters. Myj™ surfactants include poly(ethylene oxide) stearates.

In certain aspects, the nonionic surfactant can include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ether, polyoxyethylene cetyl ether, polyoxyethylene stearyl ether, polyoxyethylene oleyl ether, polyoxyethylene octylphenyl ether, polyoxyethylene nonylphenyl ether, polyethylene glycol laurate, polyethylene glycol stearate, polyethylene glycol distearate, polyethylene glycol oleate, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurate, polyoxyethylene sorbitan stearate, polyoxyethylene sorbitan oleate, polyoxyethylene laurylamine, polyoxyethylene laurylamide, laurylamine acetate, hard beef tallow propylenediamine dioleate, ethoxylated tetramethyldecynediol, fluoroaliphatic polymeric ester, polyether-polysiloxane copolymer, and the like.

In certain aspects, the additive is a combination of sodium hyaluronate, niacinamide, ceramide NP, ceramide AP, ceramide EOP, phytosphingosine, cholesterol, sodium lauroyl lactylate, carbomer, xanthan gum, tetrasodium EDTA, essential oils, plant hydrosol, and fragrance.

In certain aspects, the additive is a pharmaceutical. In some embodiments these are analgesics selected from aspirin, ibuprofen, naproxen, acetaminophen, opioids, lidocaine, or capsaicin. In some embodiments these are relaxants selected from cyclobenzaprine, baclofen tizanidine, methocarbamol, carisoprodol, and diazepam. In some embodiments, these are steroids selected from dexamethasone, triamcinolone acetonide, hydrocortisone, prednisone, methylprednisolone, fluticasone, betamethasone, beclomethasone, and clobetasol. In certain embodiments these are antibiotics selected from amoxicillin, azithromycin, doxycycline, ciprofloxacin, or cephalexin. In certain embodiments these are antifungals such as fluconazole, ketoconazole, terbinafine, clotrimazole, or nystatin. In certain embodiments these are anti-clotting agents selected from heparin, enoxaparin, apixaban, aspirin, warfarin, or apixaban. In certain embodiments these are ingredients that promote tissue repair such as epidermal growth factors, hormones, peptides, or polysaccharides. In some embodiments these are immunomodulators such as calcineurin inhibitors, TNF inhibitors, interleukin-6 inhibitors, azathioprine, mycophenolate, mofetil, methotrexate, interferons, or janus kinase inhibitors.

In certain aspects the additive is a pharmaceutical that acts as an anti-depressant, relaxant, anti-inflammatory, anti-biotic, anti-fungal, anti-viral, pain reliever, retinoid, steroid, immunomodulator, acne medication, or scar removal medication.

In certain aspects the additive is an adhesion promoter such as trialkoxysilanes, isocyanates, cyclic ethers like epoxides, peptides like arginine, glycine-aspartic acid, collagen or collagen peptides, adhesive proteins like mussel foot protein-5 or synthetic derivatives, 3,4-dihydroxyphenylanine (DOPA), or polymers with high quantities of amine, carboxyl, hydroxyl, and sulfhydryl groups.

The amount of the additive present in the topical composition can vary. In certain aspects, the additive is present in a total amount from about 0.1% to about 70% by weight based upon a total weight of the composition. In another aspect, the additive is present in a total amount from about 0.1%, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, or about 70% by weight based upon a total weight of the composition, where any value can be a lower and upper endpoint of a range (e.g., about 1% to about 5%, about 20% to about 40%, etc.).

Combination with Additional Materials

The APS formulations described herein may be combined with additional materials as part of a product or system.

In some embodiments APS formulations are combined with high strength materials such as carbon fiber, graphene, ceramic, metallic fibers, minerals like halloysite, cement, assorted minerals, or fiberglass. In certain embodiments the APS acts as a binding agent for the combination.

In other embodiments APS formulations are housed in flexible containers which allow them to interact with their environment while contained. In certain embodiments these flexible containers are made from plastics, rubber, or other elastomeric materials. In certain embodiments the interaction of the APS formulation with a stimulus will change its material properties and thereby alter the material properties of the assembly. In certain embodiments this change can be thought of as a self-fitting behavior whereby a mold is initially made and the change in material properties of the APS facilitates a semi-permanent or permanent fixing of the mold. In certain embodiments these housed APS formulations may expand, contract, or change the quality of a cushion.

### Preparation of the APS Compositions

The APS compositions and other coatings (e.g., APS and solvent with additives) are produced by admixing all ingredients into the solvent. In one aspect, all components are mixed for a sufficient time such that all components are dissolved or substantially dissolved in the solvent.

In some embodiments, homogenizers or shearing mixers are required.

In other embodiments, a curing step is required. In certain embodiments this step is performed with UV while in others it is performed using irradiation or heat.

### Applications of APS and APS Formulations

In certain embodiments the APS is used as an adhesive either in isolation or when formulated. In certain embodiments, an APS formulation acts as an adhesive due to the stickiness or bonding affinity of the dissolved polymer. In certain other embodiments, the APS formulation acts as a binding adhesive through the partial or complete evaporation of a solvent. In certain embodiments the APS adhesive is in a water-based formulation. In other embodiments, organic solvents are used.

In certain embodiments APS containing formulations are in the form of resins that may be used for binding surfaces or mixtures. In one aspect, the APS can be a component of an adhesive such as, for example, industrial adhesive or resin, a cosmetic adhesive, an internal or medical adhesive, or a resin for additive manufacture.

In certain embodiments the APS is used in the treatment of disease either on its own or in formulations.

In certain embodiments the APS is used in cosmetics as a carrier, adhesive, mechanism for controlled release, film former, strengthener, or other purposes.

In certain embodiments the APS is used in commercial, cosmetic, or industrial coatings.

In certain embodiments the APS is used as a sealant in commercial, cosmetic, industrial, or biomedical applications.

In certain embodiments the APS is applied to fibers or textiles to improve material properties such as strength, resistance to deformation, or water resistance. In certain embodiments, APS formulations may be applied to a textile as a coating or penetrating filler, which strengthens upon solvent evaporation and thereby improves the durability of one or more textiles. In certain embodiments the APS acts as a binding agent between layers of textiles and the combination of materials is stronger or more durable than either in isolation.

In certain embodiments, the APS is used for shape adaptive products. In certain embodiments these are achieved by housing an APS formulation in an enclosure which still permits interaction with the external environment by way of temperature, pH, or semipermeable membrane. In certain embodiments, these containers of APS formulation use flexible enclosures that allow for indentation. In certain embodiments these shape adaptive products are used to improve the fit of garments or apparel as a cushion or sizing mechanism by first deforming in response to the user and then changing their mechanical properties to maintain or improve the fit or comfort of a product.

In certain embodiments the APS is used in composites. In certain embodiments these composites are formed from high strength-weight materials like carbon fiber, Kevlar, ceramic, fiberglass, graphene, and metallic fibers.

In certain embodiments the APS is used in sensors.

In certain embodiments the APS is used in actuators, leveraging environmental responses to enable changes in mechanical properties, physical state, or shape. In certain embodiments this is accomplished by the formulation of the APS with additional polymers that allow for differences in swelling ratios or environmental response to elicit shape changes.

In various aspects, the present disclosure relates to pharmaceutical compositions comprising a therapeutically effective amount of the APS as described herein. As used herein, “pharmaceutically-acceptable carriers” means one or more of a pharmaceutically acceptable diluents, preservatives, antioxidants, solubilizers, emulsifiers, coloring agents, releasing agents, coating agents, sweetening, flavoring and perfuming agents, and adjuvants. The disclosed pharmaceutical compositions can be conveniently presented in unit dosage form and prepared by any of the methods well known in the art of pharmacy and pharmaceutical sciences.

The disclosed pharmaceutical compositions include those suitable for oral, rectal, topical, pulmonary, nasal, and parenteral administration, although the most suitable route in any given case will depend on the particular host, and nature and severity of the conditions for which the active ingredient is being administered. In a further aspect, the disclosed pharmaceutical composition can be formulated to allow administration orally, nasally, via inhalation, parenterally, paracancerally, transmucosally, transdermally, intramuscularly, intravenously, intradermally, subcutaneously, intraperitoneally, intraventricularly, intracranially and intratumorally.

In one embodiment, pharmaceutical compositions of the present disclosure can be in a form suitable for topical administration. As used herein, the phrase “topical application” means administration onto a biological surface, whereby the biological surface includes, for example, a skin area (e.g., hands, forearms, elbows, legs, face, nails, anus and genital areas) or a mucosal membrane. By selecting the appropriate carrier and optionally other ingredients that can be included in the composition, as is detailed herein below, the compositions of the present invention may be formulated into any form typically employed for topical application. A topical pharmaceutical composition can be in a form of a cream, an ointment, a paste, a gel, a lotion, milk, a suspension, an aerosol, a spray, foam, a dusting powder, a pad, and a patch. Further, the compositions can be in a form suitable for use in transdermal devices. These formulations can be prepared, utilizing a compound of the present disclosure, or pharmaceutically acceptable salts thereof, via conventional processing methods. As an example, a cream or ointment is prepared by mixing hydrophilic material and water, together with about 5 wt % to about 10 wt % of the compound, to produce a cream or ointment having a desired consistency.

In one embodiment, the APS can be used to deliver one or more pharmaceutical compounds or therapeutic compounds. In one embodiment, the pharmaceutical compound or therapeutic compound is mixed with the APS alone or with a solvent. In another embodiment, the APS further includes one or more residues comprising a cleavable group, where the pharmaceutical compound or therapeutic compound is covalently bonded to the cleavable group. In one embodiment, wherein the cleavable group is selected from the group consisting of an arylsulfate, a disulfide, a peptide bond, a hydrazone, an acetyl group, a nitrobenzyl group, coumarin, an azide-alkyne, a thiolene group, or a maleimide.

The APS can be administered to subject in a number of different ways depending upon the disorder to be treated. When treating a skin disorder, the APS can be formulation as a topical formulation as described herein. When addressing an interna disorder, the APS can be formulated as an injectable that can be directly applied to the site of interest.

In one embodiment, the APS can be used to treat one or more skin disorders. For example, the APS can lessen the appearance of a scar, treat inflammation, treats an infection, treat acne, lessen the appearance of wrinkles, provide a barrier for a cut, abrasion, or wound, or promote healing of the skin. In another aspect, the APS can be incorporated into hair products (e.g., shampoos, gels, pastes, etc.) to enhance or improve properties of hair.

In certain embodiments, the APS can be used in medical applications. In one aspect, the APS can be used to seal a duct or perforation in a subject. The perforation can be an external perforation (e.g., on the skin) or an internal perforation. In one aspect, the APS can be used to occlude or partially block an orifice, for example for in vivo therapeutic uses. Such orifice can be a channel. Such channel can be a tear duct. Other examples of channels that can be occluded or partially blocked include a fallopian tube, a vas deferens, an artery, a blood vessel, and a lumen of a bone. The compositions herein can be used to occlude the orifice or channel thus prohibiting the transfer of liquid or solid compositions in the body. Any of the compositions described herein can be used to treat or prevent dry eye in a subject in need thereof by occluding at least one tear duct. Any of the activatable polymers herein can be used in hydrogels to occlude or partially block a tear duct in a mammal.

In another embodiment, the APS can be used to treat an eye disorder in a subject. For example, the APS can treat dry eye disease, ocular inflammation, contact lens discomfort, glaucoma, or insufficient tear volume. In one aspect, the APS can be administered to a tear duct of a subject in liquid or semi-liquid form. Upon contact with the subject's tear duct, or in response to the subject's body temperature, the APS is activated which results in a phase change converting the copolymer into solid form.

When occluding an orifice such as, for example, a tear duct, subsequent to solidification, the polymer gel herein forms a plug. The plug may be visible using the naked eye. The plug may be visible using a microscope, magnifying glass, or a magnifying instrument. In certain embodiments, the plug may not be visible.

The plug may be removed by mechanical means or by application of a stimulus. Mechanical means include the use of forceps, aspiration, irrigation, application of pressure to the duct, or an applicator tip. For example, mechanical removal of the plug may include locating the plug, inserting the forceps into the channel, engaging the plug, removing the plug, and checking for patency of the channel. Stimuli removal involves applying a stimulus to the plug, such as irrigation, or application of a cold pack, thereby causing the plug to dissolve. In some embodiments the stimulus does not dissolve the gel plug but changes its mechanical properties. In some embodiments, the irrigation fluid is approximately less than the transition temperature. In some embodiments, the irrigation fluid is less than 32° C. The irrigation fluid may be water, saline solution, mineral oil, and the like. In some embodiments, any of the triggers described herein can be used to dissolve, soften, or de-anchor a plug. For example, stimuli removal may include locating the plug, flushing the channel with fluid, and checking the channel for patency of the channel.

### Kits

Described herein are kits that include the APS formulations in a storage device and instructions for use. In certain aspects, the storage device can be fitted with a pump for delivering the topical composition to skin. In other aspects, the kit can include an applicator such as, for example, a dropper, a brush, or an injector to apply the topical composition to the skin surface. The storage device can be made of any material including, but not limited to, glass or plastic.

### Aspects

A copolymer comprising at least one residue from the monomers in Group (a), Group (b), and Group (c):
(a) a C₁-C₄ N-alkyl acrylamide, a C₁-C₄ N,N-dialkyl acrylamide, or a combination thereof;
(b) a C₁-C₁₈ alkyl acrylate, a C₁-C₁₈ alkyl methacrylate, or a combination thereof; and
(c) a hydrophilic monomer.

The copolymer of Aspect 1, wherein the monomer of Group (a) is selected from the group consisting of n-isopropylacrylamide, N-propylacrylamide, N-propylmethacrylamide, N-ethoxyethylacrylamide, N-tetrahydrofurfurylacrylamide, N-tetrahydrofurfurylmethacrylamide, N,N-diethylacrylamide, N-isopropylmethacrylamide, N-tert-butylacrylamide, N-ethylacrylamide, N-cyclopropylacrylamide, N,N-dimethylacrylamide, N,N-diethylacrylamide, N-ethylacrylamide, or any combination thereof.

The copolymer of Aspect 1, wherein the monomer Group (a) is n-isopropylacrylamide.

The copolymer of any one of Aspects 1-3, wherein the residue from Group (a) is from about 50 mole percent to about 99 mole percent of the copolymer.

The copolymer of any one of Aspects 1-4, wherein the monomer from Group (b) is an C₁-C₁₈ alkyl acrylate.

The copolymer of any one of Aspects 1-4, wherein the monomer from Group (b) is methyl acrylate, ethyl acrylate, propyl acrylate, butyl acrylate, hexyl acrylate, heptyl acrylate, octyl acrylate, ethyl hexyl acrylate, or any combination thereof.

The copolymer of any one of Aspects 1-4, wherein the monomer from Group (b) is hexyl acrylate, ethyl hexyl acrylate, dodecyl acrylate, stearyl acrylate, or butyl acrylate.

The copolymer of any one of Aspects 1-7, wherein the residue from Group (b) is from about 0.05 mole percent to about 20 mole percent of the copolymer.

The copolymer of any one of Aspects 1-8, wherein the monomer from Group (c) is selected from the group consisting of acrylamide, acrylic acid, methacrylic acid, a hydroxyalkyl acrylate (e.g., hydroxyethyl acrylate), a halogenated acrylate (e.g., 2-bromoethyl acrylate), vinyl alcohol, halogenated vinyl, hydroxyalkyl vinyl sulfide, N-(3-methoxypropyl) acrylamide, acrylic acid, N-hydroxyethyl acrylamide, methylenesuccinic acid, N-acryloxysuccinimide, maleic anhydride, methyl vinyl ether, vinyl ether, tetrabutylammonium acrylate, tetrabutylammonium styrene sulfonate, 2-acrylamido-2-methyl-1-propanesulfonic acid, 3-[(3-acrylamidopropyl) dimethylammonio] propanoate, 3-methyl-1-vinyl-1H-imidazol-3-ium methyl sulfate, [(2-acrylate)ethyl dimethylammonium acrylate, (2-acrylate) ethyl dimethylammonium methacrylate (2AEDMAM), tributyl-(4-vinylbenzyl)ammonium sulfopropyl acrylate, trihexyl-(4-vinylbenzyl)ammonium sulfopropyl acrylate, or any combination thereof

The copolymer of any one of Aspects 1-8, wherein the monomer from Group (c) comprises an acrylate or methacrylate with a dialkylimidazolium group, an alkylpyridinium group, or a tetraalkylammonium group.

The copolymer of any one of Aspects 1-8, wherein the monomer from Group (c) is acrylamide.

The copolymer of any one of Aspects 1-11, wherein the residue from Group (c) is from about 1 mole percent to about 30 mole percent of the copolymer.

The copolymer of Aspect 1, wherein the residue from Group (a) is n-isopropylacrylamide, the residue from Group (b) is butyl acrylate, and the residue from Group (c) is acrylamide.

The copolymer of Aspect 1, wherein the copolymer consists essentially of residues of n-isopropylacrylamide, ethyl-hexyl acrylate, and acrylamide.

The copolymer of Aspect 1, wherein the copolymer consists of residues of n-isopropylacrylamide, butyl acrylate, and acrylamide.

The copolymer of any one of Aspects 13-15, wherein the residue from n-isopropylacrylamide is from about 80 mole percent to about 95 mole percent of the copolymer, the residue from the alkyl acrylate is from about 0.5 mole percent to about 10 mole percent of the copolymer, and the residue from acrylamide is from about 5 mole percent to about 20 mole percent of the copolymer.

The copolymer of Aspect 1, wherein the residue from the Group (a) monomer is from about 80 mole percent to about 95 mole percent of the copolymer, the residue from the Group (b) monomer is from about 0.5 mole percent to about 10 mole percent of the copolymer, and the residue from the Group (c) monomer is from about 5 mole percent to about 20 mole percent of the copolymer.

The copolymer of any one of Aspects 1-17, wherein the copolymer is covalently crosslinked.

The copolymer of Aspect 18, wherein the covalent crosslinker is a bis-acrylamide compound or a bis-acrylate compound.

The copolymer of Aspect 18, wherein the covalent crosslinker is selected from the group consisting of methylenebisacrylamide, polyethyleneglycol diacrylate, ethylene glycol dimethacrylate, N-(1-hydroxy-2,2-dimethoxyethyl)acrylamide, divinylbenzene, phenylenediacrylamide, diurethane dimethacrylate, 1,1,1-trimethylolpropane triacrylate, 1,1,1-trimethylolpropane trimethacrylate, pentaerythritol tetraacrylate, dipentaerythritol pentaacrylate, and any combination thereof.

The copolymer of any one of Aspects 1-20, wherein the copolymer further comprises one or more residues comprising a cleavable group.

The copolymer of Aspect 21, wherein the cleavable group is selected from the group consisting of an arylsulfate, a disulfide, a peptide bond, a hydrazone, an acetyl group, a nitrobenzyl group, coumarin, an azide-alkyne, a thiolene group, or a maleimide.

The copolymer of Aspects 21 or 22, wherein a pharmaceutical compound or therapeutic compound is bonded to the cleavable group.

The copolymer of any one of Aspects 1-23, wherein the copolymer has a number average molecular weight of about 10,000 to about 300,000 daltons.

A composition comprising the copolymer of any one of Aspects 1-24 and a solvent.

The composition of Aspect 25, wherein the solvent comprises a polar organic solvent, a mid-polar organic solvent, water, or a combination thereof.

The composition of Aspect 26, wherein the solvent comprises water.

The composition of Aspect 26, wherein the solvent comprises an alcohol.

The composition of Aspect 26, wherein the solvent comprises ethyl alcohol, methyl alcohol, isopropanol, sec-butanol, n-butanol, iso-butanol, acetone, ethyl acetate, butyl acetate, 1-methoxy-2 propanol, diacetone alcohol, anisole, propyl acetate, toluene, xylene, methyl ethyl ketone, or any combination thereof.

The composition of any one of Aspects 25-29, wherein the composition further comprises an additive selected from the group consisting of a cosolvents, an additional polymer, a ceramic, a metals, a salt, a rheology modifier, a suspension agent, a dispersant, a wetting agent, a low vapor pressure solvent, a plasticizer, pigments, effect powders, fragrance, an antimicrobial agent, an emollient, an emulsifier, a solubilizer, a humectant, a stabilizer, an exfoliant, a lipid or oil, a vitamin, a biological molecule, an essential oil, a fragrance, drug carrier, a preservative, a thickener, color additive, pH adjuster, a surfactant, a pharmaceutical, or any combination thereof.

The composition of any one of Aspects 25-30, wherein the copolymer is from about 1 weight percent to about 45% weight percent of the composition.

A pharmaceutical composition comprising the copolymer of any one of Aspects 1-24 and a pharmaceutically acceptable carrier.

The composition of Aspect 32, wherein the composition is a topical formulation.

The composition of Aspect 32, wherein the topical composition is a lotion, a mask, or a skincare product.

A method for sealing a duct or perforation in a subject, the method comprising applying the copolymer of any one of Aspects 1-24 or the composition of any one of Aspects 25-31 to the perforation or duct in the subject.

The method of Aspect 35, wherein the copolymer or composition is applied to the skin or hair of the subject.

The method of Aspect 35, wherein the copolymer or composition is applied to the ocular region of the subject.

A method for treating the skin of a subject, the method comprising applying the copolymer of any one of Aspects 1-24 or the composition of any one of Aspects 25-31 to the skin of the subject.

The method of Aspect 38, wherein the method lessens the appearance of a scar, treats inflammation, treats an infection, treats acne, lessen the appearance of wrinkles, provides a barrier for a cut, abrasion, or wound, or promotes healing of the skin.

A method for treating an eye disorder in a subject, the method comprising applying the copolymer of any one of Aspects 1-24 or the composition of any one of Aspects 25-31 to the eye or ocular region of the subject.

The method of Aspect 40, wherein the eye disorder is dry eye disease, ocular inflammation, contact lens discomfort, glaucoma, or insufficient tear volume.

An adhesive comprising the copolymer of any one of Aspects 1-24.

The adhesive of Aspect 42, wherein the adhesive is industrial adhesive or resin, a cosmetic adhesive, an internal or medical adhesive, or a resin for additive manufacture.

An article of apparel or textile comprising the copolymer of any one of Aspects 1-24.

The article of Aspect 44, wherein the apparel or textile is a responsive textile or self-fitting material.

A kit comprising (i) a topical composition comprising the copolymer of any one of Aspects 1-24 and (ii) instructions applying the composition to a subject.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, and methods described and claimed herein are made and evaluated and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, the temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to further optimize the reagent consumption while at the same time increase the extraction efficiency.

### Example 1—Synthesis of an APS by Free Radical Polymerization

NIPAM (70 g), butyl acrylate (10 g), acrylamide (20 g), and AIBN (0.322 g) were dissolved in 160 mL of ethanol. The solution was purged with nitrogen for 2 hours and then heated to 55 C for 4 hours under inert atmosphere. The reaction mixture was allowed to cool and then precipitated into water with agitation to remove impurities. Product is then either redissolved into an organic solvent for spray drying or dried in a vacuum to remove residue before grinding to a powder.

### Example 2—Synthesis of APS by RAFT

NIPAM (70 g), ethylhexyl acrylate (5 g), acrylic Acid (10 g), 2-(dodecylthiocarbonothioylthio)-2-methylpropionic acid (1 g), and AIBN (0.5 g) were dissolved in 200 ml of ethanol. The solution was purged with nitrogen for 2 hours with stirring and then heated to 55 C for 4 hours under inert atmosphere. The reaction mixture was allowed to cool and then precipitated into water with agitation to remove impurities. Product is then either redissolved into an organic solvent for spray drying or dried in a vacuum to remove residue before grinding to a powder.

### Example 3—Synthesis of APS by RAFT

NIPAM (60 g), ethylhexyl acrylate (10 g), methylene biscrylamide (20 g), CuBr (0.05 g), PMDETA (0.05 g), and BriB (0.05 g) were dissolved in 200 mL of ethanol. The solution was purged with nitrogen for 2 hours and then heated to 55 C for 4 hours under inert atmosphere. The reaction mixture was allowed to cool and then precipitated into water with agitation to remove impurities. Product is then either redissolved into an organic solvent for spray drying or dried in a vacuum to remove residue before grinding to a powder.

### Example 4—APS Steroid Hydrogel (w/W)

| | |
|---|---|
| Water | 64.9% |
| APS | 33% |
| Glycerin | 1% |
| Methyl Cellulose | 1% |
| Triamcinolone acetonide | 0.1% |

### Example 5—APS Gel Sealant (w/W)

| | |
|---|---|
| Water | 66% |
| APS | 34% |

### Example 6—Modification of APS Properties

When used in the appropriate solvent, an APS allows for tailored mechanical properties within a range of possible smart behavior trigger points. Using the example of a hydrogel with a cloud point temperature, an N-isopropylacrylamide (NIPAM) copolymer may have desirable mechanical properties, but a cloud point (Tcp) that renders its formulation unusable for a specific application. Examples of these effects are shown in Table 1. This cloud point may be further affected by the excipients included in the formulation through well document phenomena.

TABLE 1
N-Isopropylacrylamide/Butyl Acrylate Copolymers

| NIPAM | BA | Tcp ° C. |
|---|---|---|
| 100% | 0% | 32 |
| 99% | 1% | 29 |
| 98% | 2% | 27.5 |
| 97% | 3% | 26 |
| 95% | 5% | 18 |

APS utilizes counterbalancing effects of additional monomer groups to tailor the mechanical properties while maintaining a desired Tcp. The balancing effects of APS components on the trigger point of APS-based formulations can be observed in Table 2, where NIPAM, butyl acrylate and acrylamide are used as illustrative monomers. It can be observed that as the relative portion of alkyl acrylate in the polymer increases, the Tcp trigger point lowers. At the same time, if a hydrophilic group is added, it can counterbalance these effects.

TABLE 2
N-Isopropylacrylamide/Butyl Acrylate/Acrylamide Copolymers

| NIPAM | BA | AM | Tcp ° C. |
|---|---|---|---|
| 90% | 1% | 9 | 35 |
| 80% | 5% | 15 | 34 |
| 90% | 2% | 8 | 33 |
| 90% | 3% | 7% | 31 |
| 86% | 5% | 9% | 30 |
| 88% | 5% | 7% | 29 |
| 89% | 5% | 6% | 28.5 |
| 85% | 6% | 9% | 28.5 |
| 90% | 5% | 5% | 27.5 |
| 87% | 6% | 7% | 27.5 |

### Example 7—Benefits of APS Properties

The customizable solidification temperature for APS hydrogels already provides utility across a range of solvent-borne formulations. An additional benefit of these systems is also their recovery after deformation. The data in Table 3 compares rotational viscosity during 3 step thixotropy for a binary N-isopropylacrylamide-butyl acrylate copolymer (sample 1) with the APS N-isopropylacrylamide-butyl acrylate-acrylamide copolymer (sample 2) and cross-linked APS (sample 3). The APS exhibits faster recovery following high shear below its solidification temperature.

TABLE 3
Viscosity (cP) Measured During 3-Step Thixotropy

| | Low | Higher | Low | |
|---|---|---|---|---|
| Sample | Shear^{a} | Shear^{b} | Shear^{c} | Recovery |
| N99BA1 (1) | 4421 | 852 | 2529 | 57% |
| N88BA5AM7 (2) | 5761 | 942 | 4909 | 85% |
| N87.95BA5AM7BisAM0.05 (3) | 13850 | 1424 | 14190 | 102% |

^{a}0.01 sec⁻¹, n = 60 datapoints
^{b}2500 sec⁻¹, n = 10 datapoints
^{c}0.01 sec⁻¹, n = 30 datapoints

This is further reflected in viscoelastic properties measured using oscillatory rheology (Table 4). The APS has a much more fluid-like behavior below the solidification temperature. Above that temperature, the material approaches the same Tan value as the binary, illustrating a similar solidifying effect (Tan<1 indicates networking and more elastic behavior).

TABLE 4
Visco-Elastic Properties Across Tcp, 1% Strain-Irradiated

| | 25 C. | 35 C. | Delta | 25 C. | 35 C. |
|---|---|---|---|---|---|
| Sample | G″ | G″ | G″ | Tan | Tan |
| N99BA1 (1) | 23.4 | 2872.0 | 2848.6 | 7.8 | 1.1 |
| N88BA5AM7 (2) | 35.8 | 1038.0 | 1002.2 | 15.8 | 1.2 |
| N87.95BA5AM7BisAM0.05 (3) | 66.1 | 1010.0 | 943.9 | 4.7 | 0.9 |

Another desirable property made possible by the APS compositions is an observable resistance to changes in properties caused by irradiation. Table 5 below shows the loss modulus before and after irradiation for binary and tertiary samples, both cross-linked and not cross-linked. Binary samples undergo a 3-5-fold increase in viscosity. After the same exposure, the tertiary hydrogels remain relatively unchanged within a margin of error (−20%, +30% respectively). Incorporation of both hydrophilic and hydrophobic comonomers into an polymer that exhibits cloud point behavior seems to imbue a measure of resilience to the gel that preserves its flow properties.

TABLE 5
G″ Loss Modulation (Pa)

| Sample | Initial | Post-Irradiation | % Change |
|---|---|---|---|
| N99BA1 (1) | 1295 | 5049 | 390 |
| N98.95BA1BisAM0.05 (2) | 5229 | 28570 | 546 |
| N88BA5AM7 (3) | 354 | 281 | 79 |
| N87.95BA5AM7BisAM0.05 (4) | 637 | 824 | 129 |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed:

1. A copolymer comprising at least one residue from the monomers in Group (a), Group (b), and Group (c):
(a) a C₁-C₄ N-alkyl acrylamide, a C₁-C₄ N, N-dialkyl acrylamide, or a combination thereof;
(b) a C₁-C₁₈ alkyl acrylate, a C₁-C₁₈ alkyl methacrylate, or a combination thereof; and
(c) a hydrophilic monomer.

2. The copolymer of claim 1, wherein the monomer of Group (a) is selected from the group consisting of n-isopropylacrylamide, N-propylacrylamide, N-propylmethacrylamide, N-ethoxyethylacrylamide, N-tetrahydrofurfurylacrylamide, N-tetrahydrofurfurylmethacrylamide, N,N-diethylacrylamide, N-isopropylmethacrylamide, N-tert-butylacrylamide, N-ethylacrylamide, N-cyclopropylacrylamide, N,N-dimethylacrylamide, N,N-diethylacrylamide, N-ethylacrylamide, or any combination thereof.

3. The copolymer of claim 1, wherein the monomer Group (a) is n-isopropylacrylamide.

4. The copolymer of claim 1, wherein the residue from Group (a) is from about 50 mole percent to about 99 mole percent of the copolymer.

5. The copolymer of claim 1, wherein the monomer from Group (b) is an C₁-C₁₈ alkyl acrylate.

6. The copolymer of claim 1, wherein the monomer from Group (b) is hexyl acrylate, ethyl hexyl acrylate, dodecyl acrylate, stearyl acrylate, or butyl acrylate.

7. The copolymer of claim 1, wherein the residue from Group (b) is from about 0.05 mole percent to about 20 mole percent of the copolymer.

8. The copolymer of claim 1, wherein the monomer from Group (c) is selected from the group consisting of acrylamide, acrylic acid, methacrylic acid, a hydroxyalkyl acrylate (e.g., hydroxyethyl acrylate), a halogenated acrylate (e.g., 2-bromoethyl acrylate), vinyl alcohol, halogenated vinyl, hydroxyalkyl vinyl sulfide, N-(3-methoxypropyl)acrylamide, acrylic acid, N-hydroxyethyl acrylamide, methylenesuccinic acid, N-acryloxysuccinimide, maleic anhydride, methyl vinyl ether, vinyl ether, tetrabutylammonium acrylate, tetrabutylammonium styrene sulfonate, 2-acrylamido-2-methyl-1-propanesulfonic acid, 3-[(3-acrylamidopropyl) dimethylammonio] propanoate, 3-methyl-1-vinyl-1H-imidazol-3-ium methyl sulfate, [(2-acrylate)ethyl dimethylammonium acrylate, (2-acrylate) ethyl dimethylammonium methacrylate (2AEDMAM), tributyl-(4-vinylbenzyl)ammonium sulfopropyl acrylate, trihexyl-(4-vinylbenzyl)ammonium sulfopropyl acrylate, or any combination thereof

9. The copolymer of claim 1, wherein the monomer from Group (c) comprises an acrylate or methacrylate with a dialkylimidazolium group, an alkylpyridinium group, or a tetraalkylammonium group.

10. The copolymer of claim 1, wherein the monomer from Group (c) is acrylamide.

11. The copolymer of claim 1, wherein the residue from Group (c) is from about 1 mole percent to about 30 mole percent of the copolymer.

12. The copolymer of claim 1, wherein the residue from Group (a) is n-isopropylacrylamide, the residue from Group (b) is butyl acrylate, and the residue from Group (c) is acrylamide.

13. The copolymer of claim 1, wherein the copolymer consists essentially of residues of n-isopropylacrylamide, ethyl-hexyl acrylate, and acrylamide.

14. The copolymer of claim 1, wherein the copolymer consists of residues of n-isopropylacrylamide, butyl acrylate, and acrylamide.

15. The copolymer of claim 13, wherein the residue from n-isopropylacrylamide is from about 80 mole percent to about 95 mole percent of the copolymer, the residue from the alkyl acrylate is from about 0.5 mole percent to about 10 mole percent of the copolymer, and the residue from acrylamide is from about 5 mole percent to about 20 mole percent of the copolymer.

16. The copolymer of claim 1, wherein the residue from the Group (a) monomer is from about 80 mole percent to about 95 mole percent of the copolymer, the residue from the Group (b) monomer is from about 0.5 mole percent to about 10 mole percent of the copolymer, and the residue from the Group (c) monomer is from about 5 mole percent to about 20 mole percent of the copolymer.

17. The copolymer of claim 1, wherein the copolymer is covalently crosslinked.

18. The copolymer of claim 1, wherein the copolymer further comprises one or more residues comprising a cleavable group.

19. The copolymer of claim 18, wherein the cleavable group is selected from the group consisting of an arylsulfate, a disulfide, a peptide bond, a hydrazone, an acetyl group, a nitrobenzyl group, coumarin, an azide-alkyne, a thiolene group, or a maleimide.

20. The copolymer of claim 18, wherein a pharmaceutical compound or therapeutic compound is bonded to the cleavable group.

21. The copolymer of claim 1, wherein the copolymer has a number average molecular weight of about 10,000 to about 300,000 daltons.

22. A composition comprising the copolymer of claim 1 and a solvent.

23. The composition of claim 22, wherein the solvent comprises a polar organic solvent, a mid-polar organic solvent, water, or a combination thereof.

24. The composition of claim 22, wherein the composition further comprises an additive selected from the group consisting of a cosolvents, an additional polymer, a ceramic, a metals, a salt, a rheology modifier, a suspension agent, a dispersant, a wetting agent, a low vapor pressure solvent, a plasticizer, pigments, effect powders, fragrance, an antimicrobial agent, an emollient, an emulsifier, a solubilizer, a humectant, a stabilizer, an exfoliant, a lipid or oil, a vitamin, a biological molecule, an essential oil, a fragrance, drug carrier, a preservative, a thickener, color additive, pH adjuster, a surfactant, a pharmaceutical, or any combination thereof.

25. The composition of claim 22, wherein the composition is a topical formulation.

26. A method for sealing a duct or perforation in a subject, the method comprising applying the copolymer of claim 1 to a subject.

27. The method of claim 26, wherein the copolymer or composition is applied to the ocular region of the subject.

28. A method for treating the skin or hair of a subject, the method comprising applying the copolymer of claim 1 to the skin or hair of the subject.

29. A method for treating an eye disorder in a subject, the method comprising applying the copolymer of claim 1 to the eye or ocular region of the subject.

30. An adhesive comprising the copolymer of claim 1.

31. The adhesive of claim 30, wherein the adhesive is industrial adhesive or resin, a cosmetic adhesive, an internal or medical adhesive, or a resin for additive manufacture.
